(19) United States
(12) Patent Application Publication
(10) Pub. No.: US 2004/0104084 A1
(43) Pub. Date: Jun. 3, 2004

(54) BRAKE MEMBER, DISK BRAKE, DRUM BRAKE AND METHOD FOR MANUFACTURING BRAKE MEMBERS

(75) Inventor: Johan HULTEN, Goteborg (SE)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO LASTVAGNAR AB, Goteborg (SE)

(21) Appl. No.: 10/605,554

(22) Filed: Oct. 8, 2003

Related U.S. Application Data
(63) Continuation of application No. PCT/SE02/00497, filed on Mar. 15, 2002.

(30) Foreign Application Priority Data
Apr. 10, 2001 (SE) 0101269-9

(51) Int. Cl. F16D 65/00

(52) U.S. Cl. 188/73.1

(57) ABSTRACT

Method and arrangement for providing a brake member having a rear plate that carries a brake lining (14) that has at least one contact surface (16), side edges (18) and end edges (19, 20). To avoid brake squeal, the wear resistance of the brake lining (14) is varied in the longitudinal direction between the two end edges (19, 20) in such a manner that at least one of the end edge portions (19a, 20a) of the brake lining (14) has lower wear resistance than a remaining part of the brake lining (14).

### CROSS REFERENCE TO RELATED APPLICATIONS

This present application is a continuation patent application of International Application No. PCT/SE02/00497 filed 15 Mar. 2002 which was published in English pursuant to Article 21(2) of the Patent Cooperation Treaty, and which claims priority to Swedish Application No. 0101269-9 filed 10 Apr. 2001. Both applications are expressly incorporated herein by reference in their entireties.

### BACKGROUND OF INVENTION

1. Technical Field

The present invention relates to a brake member having a rear plate that carries a brake lining that has at least one contact surface, side edges and end edges. More particularly, a brake member in which the occurrence of brake squeal can be reduced by virtue of the design of a brake lining.

2. State of the Art

When vehicles are braked, what is known as brake squeal sometimes arises, and this can happen with respect to both disk brakes and drum brakes. Typical frequencies of this noise lie in the kHz range in an area that is within the range of human hearing sensitivity. It is true that the sound generated decreases with distance from the sound source, but it can be as much as around 140 dB at locations close to the brake itself. City buses that stop repeatedly within densely populated areas present special problems, if for no other reason, that they are annoying to most people in these areas. In fact, brake squeal is a common cause for complaint about new private cars, trucks and buses. Even though brake squeal does not affect the braking effect or safety, the problem is nevertheless of great significance and begs solution. The problem also occurs in vehicles with ABS-type brakes.

A substantial amount of analysis has gone into the problem of brake squeal, and many different solutions have been proposed and tested. Attempts have been made, for example, to dimension components in the brake system in order to bring about a change in the natural frequency of the system; but attempts of this nature have not met with great success and sufficient brake squeal reduction has not yet been accomplished.

U.S. Pat. No. 5,145,037 for example, discloses a disk brake in which it is intended to reduce the occurrence of brake squeal by virtue of end areas of the brake disk being chamfered within an area of which the extent is dependent on the width between claws forming part of a brake caliper. These claws bear a rear plate in which the brake lining is arranged. One disadvantage of this solution, however, is that the chamfered end of the lining, that is the front end in the direction of rotation, tends to feed dirt in between the brake disk and the lining. This condition that is created can interfere with the braking capacity momentarily. Moreover, chamfering reduces the effective volume of the wear material of the lining.

Another disk brake is disclosed in U.S. Pat. No. 4,485,989 that is intended to reduce brake squeal by virtue of the brake lining being provided with a portion made of lubricating solid material that affects lubrication of the brake disk.

Although the abovementioned proposals contribute to reducing the occurrence of brake squeal under certain given conditions, these solutions do not contribute to reducing the occurrence of brake squeal when varying load is applied to the brake member. Problems can also arise in disk brakes including these types of arrangements for lubricating the brake disk because the braking capacity is initially reduced more than normal when it is cold or wet.

### SUMMARY OF INVENTION

One object of the invention is to provide a brake member in which the occurrence of brake squeal is reduced when varying load is applied to the brake member, while at the same time retaining uniform (even) braking characteristics. This object is achieved by means of a brake member in which the wear resistance of the brake lining varies in the longitudinal direction between the two end edges in such a manner that at least one of the end edge portions of the brake lining has lower wear resistance than the remaining part of the brake lining.

In another embodiment, the invention takes the form of, or provides a disk brake or a drum brake in which the occurrence of brake squeal under varying applied load is reduced.

Yet another object of the invention is to provide a method for manufacturing a brake member in which the occurrence of brake squeal under varying load applied to the brake member is reduced and in which the brake lining is designed so that its wear resistance varies in the longitudinal direction between the two end edges in such a manner that at least one of the end edge portions of the brake lining has lower wear resistance than the remaining part of the brake lining.

From a more theoretical perspective, the article “An Assumed Modes Method Approach to Disc Brake Squeal Analysis,” Society of Automotive Engineers, 1999-01-1335 by Hultén and Flint discusses the fact that when considering the rotational symmetry of a brake member, for example a brake disk, two modes exist for each natural frequency of the brake member. When a mode pair exists for a natural frequency, a wave can propagate through the brake member if excitation energy is supplied. In this case, the noise known as brake squeal can arise. When a brake lining interconnects a brake disk, or alternatively a brake drum, and a brake lining, the coupled modes are split up into separate natural frequencies for the system. Non-conservative forces, such as friction forces for example, tend to couple these freestanding modes and combine them into a common natural frequency, in which case brake squeal can arise. In order to avoid brake squeal from occurring, the system thus needs to be designed so that separation of a set of modes, which principally have natural frequencies between 1 and 15 kHz, can be maintained. The coupling can thus give rise to a number of different natural frequencies which are dependent on the interaction between the lining and the brake member; that is to say, either the disk or the drum.

In order to facilitate the construction of a brake member in which the risk of brake squeal is reducedfor the majority of natural frequencies, and preferably all natural frequencies within the abovementioned range, it is important that the interaction between the lining and the disk or drum takes place in a predictable manner. Referring to the accompanying figures, FIG. 1 depicts a situation in which a variation in the wear resistance in certain regions affects the coupling together of split modes. In this case, a transition can take place from a stable state 10 to an unstable state 11 at a point 12 that corresponds to a critical level of the wear resistance. By virtue of the present invention, this point can be moved to a higher level; that is to say, to the right along the W-axis in the figure.

### BRIEF DESCRIPTION OF DRAWINGS

The invention will be described in greater detail below with reference to the accompanying figures of the drawing, in which:

FIG. 1 is a graph displaying a curve in which the units frequency (f) and wear resistance (W) illustrate the phenomenon of the coupling of split modes;

FIG. 2 is a schematic side view of a brake lining configured according to the teachings of the present invention, and

FIG. 3 is a schematic side view of an alternative embodiment of the type of brake lining shown in FIG. 2.

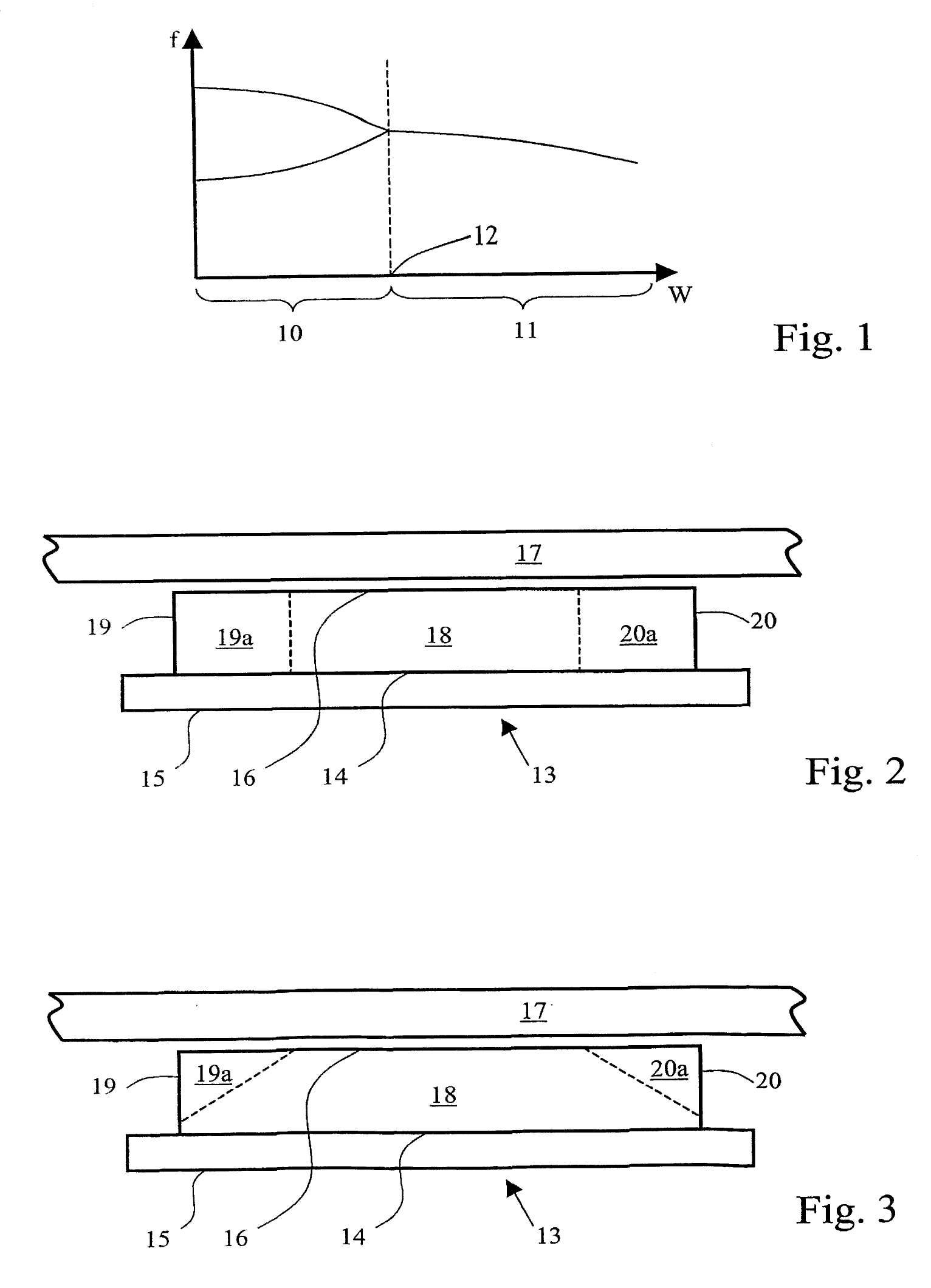

### DETAILED DESCRIPTION

FIG. 2 shows a side view of a brake member 13 configured according to the teachings of the present invention. FIG. 3 shows a brake member 13 with alternatively designed end edge portions 19a, 20a. These brake members are arranged to interact with a brake disk 17 or a brake drum by virtue of means which are not shown, but which are well known to persons skilled in the relevant art. Examples of the interaction and the necessary component means for providing a functioning brake are described, for example in U.S. Pat. No. 5,145,037 and GB 2143916 regarding a disk brake and in SE 504 272 regarding a drum brake and in which a brake member according to the invention can be incorporated and utilized.

The brake member 13 comprises (includes, but is not limited to) a brake lining 14 and a rear plate 15. The brake lining 14 and the rear plate 15 are preferably made in one piece (of one-piece construction). Alternatively, the brake lining can be fixed to the rear plate in a manner that is well known to the person skilled in the art.

The brake lining constitutes a wearing surface when the brake member is used for braking, and the rear plate distributes the pressing force from brake cylinders (not shown) to the brake lining when the brake member is used in a brake. An example of the design of a brake with brake cylinders is provided, for example, in U.S. Pat. No. 5,145,037.

The exemplary brake lining has a contact surface 16 intended to be pressed against a brake disk 17 or, as the case may be, against a brake drum. The lining also has side edges 18 and end edges 19, 20. According to the invention, the brake lining 14 is designed in such a way that the wear resistance varies in the longitudinal direction between the two end edges 19, 20 in such a manner that at least one of the end edge portions 19a, 20a of the brake lining has lower wear resistance than the remaining part of the brake lining. This variation can take place either gradually along the end edge portion, or in a stepped manner in the border portion between the end edge portion and the remaining part of the brake lining. This variation can take place at either end edge, or at both end edges. The difference in wear resistance between this end portion and the remaining part of the brake lining is suitably at least on the order (roughly) fiver percent.

According to an advantageous variant (embodiment) of the invention, the difference in wear resistance is at least ten percent.

According to another advantageous variant of the invention, the difference in wear resistance is at least fifteen percent.

According to another advantageous variant of the invention, the difference in wear resistance is at least twenty percent. The length of the end portion 19a, 20a is suitably between five and forty percent of the total distance between the end edges 19, 20.

According to another advantageous variant of the invention, the length of the end portion is suitably between ten and thirty percent of the total distance between the end edges 19, 20. The variation in the wear resistance does not have to be limited to the end edge portions 19a, 20a, but can also be distributed over the entire length of the brake lining so that one end edge has lower wear resistance than the other. In this connection, the variation in wear resistance can take place in a stepped manner, or continuously. At the same time, it is possible to vary the coefficient of friction of the brake lining in the longitudinal direction between the two end edges in such a manner that at least one of the end edge portions of the brake lining has a lower coefficient of friction than the remaining part of the brake lining. In this connection, an advantageous balance between wear resistance and coefficient of friction is obtained, which can even out the force distribution on a brake lining.

The brake lining and the rear plate are manufactured from materials well known to the person skilled in the art.

The invention also relates to a method for manufacturing a brake member comprising a rear plate bearing (carrying) a brake lining that has at least one contact surface and side edges and end edges. The brake lining is designed so that its wear resistance varies in the longitudinal direction between the two end edges 19, 20. In this connection, at least one of the end edge portions 19a and/or 20a of the brake lining has lower wear resistance than the remaining part of the brake lining.

The invention can be used for a variety of types of disk brakes and drum brakes well known to the person skilled in the art.

1. A brake member comprising:
a rear plate bearing a brake lining (14), the brake lining (14) having at least one contact surface (16), side edges (18) and end edges (19, 20);
the brake lining (14) having a resistance to wear that varies in a longitudinal direction between the two end edges (19, 20) so that at least one of the end edge portions (19a and/or. 20a) of the brake lining (14) has lower wear resistance than a remaining part of the brake lining (14).

2. The brake member as recited in claim 1, wherein the variation in resistance to wear of the brake lining (14) takes place in a stepped manner in a border portion between an end edge portion (19a and/or 20a) and the remaining part of the brake lining (14).

3. The brake member as recited in claim 1, wherein the variation in resistance to wear of the brake lining (14) takes place in a stepped manner from one end edge to the other thereby establishing that one end edge (19 or 20) has lower resistance to wear than the other end edge (19 or 20).

4. The brake member as recited in claim 1, wherein the variation in resistance to wear of the brake lining (14) takes place gradually from one end edge to the other so that one end edge (19 or 20) has lower resistance to wear than the other.

5. The brake member as recited in claim 1 wherein the variation in resistance to wear of the brake lining (14) is at least approximately five percent.

6. The brake member as recited in claim 1 wherein the variation in resistance to wear of the brake lining (14) is at least approximately ten percent.

7. The brake member as recited in claim 1 wherein the variation in resistance to wear of the brake lining (14) is at least approximately fifteen percent.

8. The brake member as recited in claim 1 wherein the variation in resistance to wear of the brake lining (14) is at least approximately twenty percent.

9. The brake member as recited in claim 1, wherein the variation in resistance to wear of the brake lining (14) takes place gradually in an end edge portion (19a and/or 20a) delimited between a respective end edge (19 and/or 20) and the remaining part of the brake lining (14).

10. The brake member as recited in claim 2, wherein the length of the end portion (19a and/or 20a) is between five and forty percent of the distance between the end edges (19, 20).

11. The brake member as recited in claim 10, wherein the length of the end portion (19a and/or 20a) is between ten and thirty percent of the distance between the end edges (19, 20).

12. The brake member as recited in claim 1, wherein the coefficient of friction of the brake lining (14) also varies in the longitudinal direction between the two end edges (19, 20) in such a manner that at least one of the end edge portions (19a and/or 20a) of the brake lining has a lower coefficient of friction than the remaining part of the brake lining.

13. The brake member as recited in claim 1, wherein the brake member constitutes a component in a disk brake arrangement.

14. The brake member as recited in claim 1, wherein the brake member constitutes a component in a drum brake arrangement.

15. A method for manufacturing a brake lining (14) intended to be borne by a rear plate (15) and that has at least one contact surface (16), side edges (18) and end edges (19, 20), the method comprises:
configuring the brake lining (14) so that a resistance to wear varies in a longitudinal direction between the two end edges (19, 20) so that at least one of the end edge portions (19a and/or 20a) of the brake lining has lower wear resistance than a remaining part of the brake lining (14).
